(19) United States
(12) Patent Application Publication
(10) Pub. No.: US 2009/0076965 A1
(43) Pub. Date: Mar. 19, 2009

(54) COUNTERACTING RANDOM GUESS ATTACKS AGAINST HUMAN INTERACTIVE PROOFS WITH TOKEN BUCKETS

(75) Inventors: Jeremy Eric Elson, Kirkland, WA (US); Jonathan Ryan Howell, Seattle, WA (US); John R. Douceur, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/856,367

(22) Filed: Sep. 17, 2007

(51) Int. Cl. G06F 21/22

(52) U.S. Cl. 705/55

(57) ABSTRACT

A system and method that facilitates and effectuates distinguishing a human from a non-human user. A human interactive proof (HIP) employs a token bucket algorithm in order to reduce the success rate for a non-human user employing a guessing or artificial intelligence to solve a substantial number of HIP challenges. The algorithm can employ token buckets associated with IP address and user session from which the user is attempting to solve the HIP challenge. If a token bucket is empty the algorithm can treat a correct response as incorrect and refill a portion of the buckets for a further attempt. This forces two correct responses to be received by a user within the refill quantity for the users bucket(s) before the user is identified as human.

### BACKGROUND

There are many Internet or web based services that have a need to distinguish between a human and a computer user interacting with the service. For example, there are many free e-mails services that allow a user to create an e-mail account by merely entering some basic information. The user is then able to use the e-mail account to send and receive e-mails. This ease of establishing e-mail accounts has allowed spammers to produce computer programs to automatically create e-mail accounts with randomly generated account information and then employ the accounts to send out thousands of spam e-mails. Web services have increasingly employed Turing test challenges (commonly known as a Completely Automated Public Turing test to tell Computers and Humans Apart (CAPTCHA™) or Human Interactive Proof (HIP)) in order distinguish between a human and a computer as the user of the web service. The web service will only allow the user to employ the service after the user has passed the HIP.

The HIP is designed so that a computer program would have difficulty passing the test, but a human can more easily pass the test. All HIPs rely on some secret information that is known to the challenger but not to the user being challenged. HIPs or CAPTCHAs™ can be divided into two classes depending on the scope of this secret. In what are herein referred to as Class I CAPTCHAs™, the secret is merely a random number, which is fed into a publicly known algorithm to yield a challenge. Class II CAPTCHAs™ employ both a secret random input and a secret high-entropy database. A critical problem in building a Class II CAPTCHA™ is populating the database with a sufficiently large set of classified, high-entropy entries.

Class I CAPTCHAs™ have many virtues. They can be concisely described in a small amount of software code; they have no long term secret that requires guarding; and they can generate a practically unbounded set of unique challenges. On the other hand, their most common realization, a challenge to recognize distorted text, evinces a disturbingly narrow gap between human and nonhuman success rates. FIG. 2A shows an example of a simple class 1 CAPTCHA™ displaying a random text string. The figure shows clearly segmented characters. Optical character recognition algorithms are competitive with humans in recognizing distinct characters, which has led researchers toward increasing the difficulty of segmenting an image into distinct character regions. FIGS. 2B through 2E show common ways in which class I CAPTCHAs™ are modified in an attempt to make it more difficult for a computer program to correctly recognize the characters. The text string can be distorted and noise can be added when rendered for display to a user. However, this increase in difficulty affects humans as well. The owners of web services must be careful to not make the challenge so difficult that it drives away real human users from expending the effort to user their service. Even relatively simple challenges can drive away a substantial number of potential customers.

Class II CAPTCHAs™ have the potential to overcome the main weaknesses described above. Because they are not restricted to challenges that can be generated by a low-entropy algorithm, they can exercise a much broader range of human ability, such as recognizing features of photographic images captured from the physical world. Such challenges evince a broad gulf between human and non-human success rates, not only because general machine vision is a much harder problem than text recognition, but also because image-based challenges can be made less bothersome to humans without drastically degrading their efficacy at blocking automatons.

An issue that can arise with both Class I and II CAPTCHAs™ is a automated computer program using random guessing or an artificially intelligent classifier to respond to the HIP challenge. For example, in the case of a text-based Class I CAPTCHA™, optical character recognitions (OCR) systems can allow an automated computer program to recognize at a fairly high percentage characters even with the distortions, convolutions, or noise that have been added to a text based challenge. Given this success rate of OCR, an automated system will achieve a pass rate for the HIP challenge that may not be acceptable to the service that is employing the HIP. Similarly for an image-based Class II CAPTCHA™, machine vision systems can provide fairly accurate classification of images and over many HIP challenges could achieve a substantial success rate. There is a need to counter the success of automated computer programs that attempt to pass CAPTCHA™ challenges.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

In accordance with one or more aspects and corresponding disclosure thereof, various features are described in connection with a HIP for distinguishing a human from a non-human. In one aspect, a HIP service employs Class I or II CAPTCHAs™ as part of its Turing test challenge. The HIP service employs a counting mechanism that tracks attempts made to pass the challenge from a single source. For example, the source may be tracked by, but is not limited to, an IP address from which a user is attempting the HIP challenge. Tracking the source can be accomplished by an appropriate means that can be implemented on the system presenting the HIP challenge, such as for example, a user session identifier. The mechanism for counting the attempts can be, but is not limited to, a token bucket algorithm. In another aspect, a plurality of tracking mechanisms for a user may be employed each having a counting mechanism.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a general block diagram HIP system employing a counting mechanism to distinguish between human and non-human users.

FIGS. 2A-2E illustrates examples of class 1 CAPTCHAs™ displaying a random text strings.

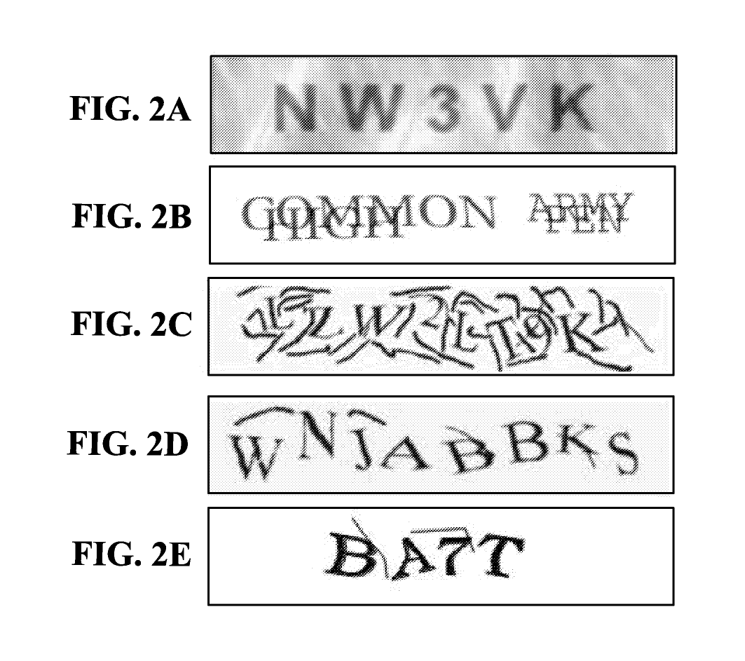

FIG. 3 shows some examples of side by side images of cats and dogs that demonstrate similarities that can cause problems for a machine vision system trying to classify the image as a cat or a dog.

FIG. 4 illustrates an example of HIP challenge displayed to a user consisting of twelve images from the Petfinder® database.

FIG. 5 illustrates a general block diagram HIP system employing a counting mechanism to distinguish between human and non-human users.

FIG. 6 illustrates a general block diagram HIP system employing an IP address based counting mechanism to distinguish between human and non-human users.

FIG. 7 illustrates a flow chart of one methodology for a computer application to employ a HIP service that utilizes token buckets to distinguish between a human and non-human user taking a HIP challenge.

FIG. 8 illustrates a flow chart of one methodology for a HIP service to employ token buckets to distinguish between a human and non-human user taking the HIP challenge.

FIG. 9 illustrates a block diagram of a computer operable to execute the disclosed HIP service.

FIG. 10 illustrates a schematic block diagram of an exemplary computing environment for implementing a HIP service in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

As used herein, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and a computer. By way of illustration, both an application running on a server and the server can be a component. One or more components can reside within a process and/or thread of execution and a component can be localized on one computer and/or distributed between two or more computers.

Throughout the discussion below, experimental results based on exemplary training sets of data are presented to further support or illustrate various aspects of the subject application. It should be appreciated and understood that such experiments are not intended to limit the scope of the systems and methods described herein to particular scenarios, operating conditions or applications but are provided as examples. Moreover, the subject application can be employed with respect to any type of service performed on the Internet, on a remote or local server, storage facility, or on any computing device or network.

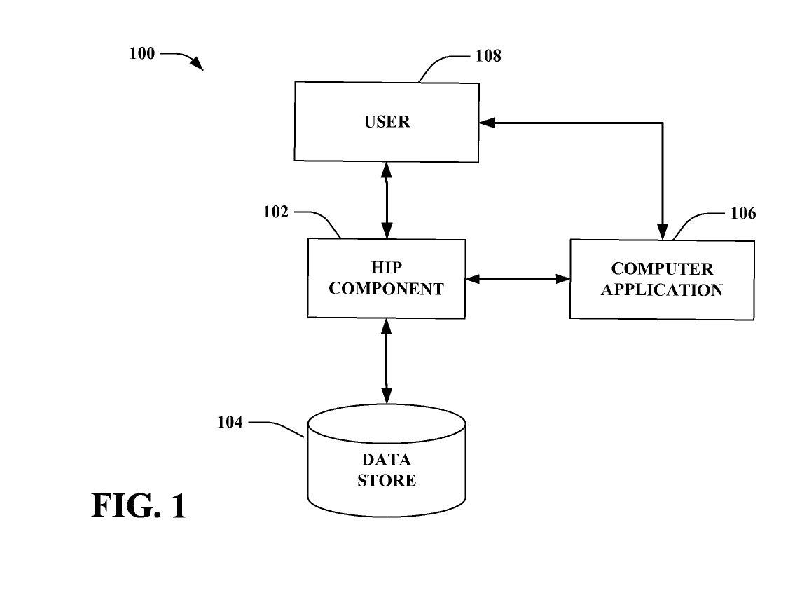

Referring to FIG. 1, there is illustrated a general block diagram HIP system 100 to distinguish between human and non-human users that employs a counting mechanism to reduce the success rate of non-human users. System 100 includes a Human Interactive Proof (HIP) component 102 that distinguishes between a human and a non-human. HIP component 102 presents one or more challenges to user 108 to determine if user 108 is a human or a computer program. The challenge can be a class I or II CAPTCHA™. For example, a class II CAPTCHA™ challenge can include presenting one or more images to user 108 from data store 104 that user 108 must correctly categorize before being allowed to partially or fully employ computer application 106. Data store 104 can contain any manually categorized data item which the user will have to classify as part of the HIP—images are just one example. Other example data items are sound data items, such as songs or commonly heard sounds (car, airplane, train). For songs the user can be asked to identify the artist, genre, song title or any other attribute of the song. Data store 104 can be a private or public data store that is remotely or locally installed to HIP component 102 or computer application 106. Data store 104 is optional in the case of a class I CAPTCHA™, for example, one that generates random character strings. The discussion that follows employs an example of a free Internet e-mail service as computer application 106 for illustrative purposes. Computer application 106 is not limited to a free e-mail service. Computer application 106 can be any Internet, intranet, or non-networked program that has a need to distinguish between a human an non-human user.

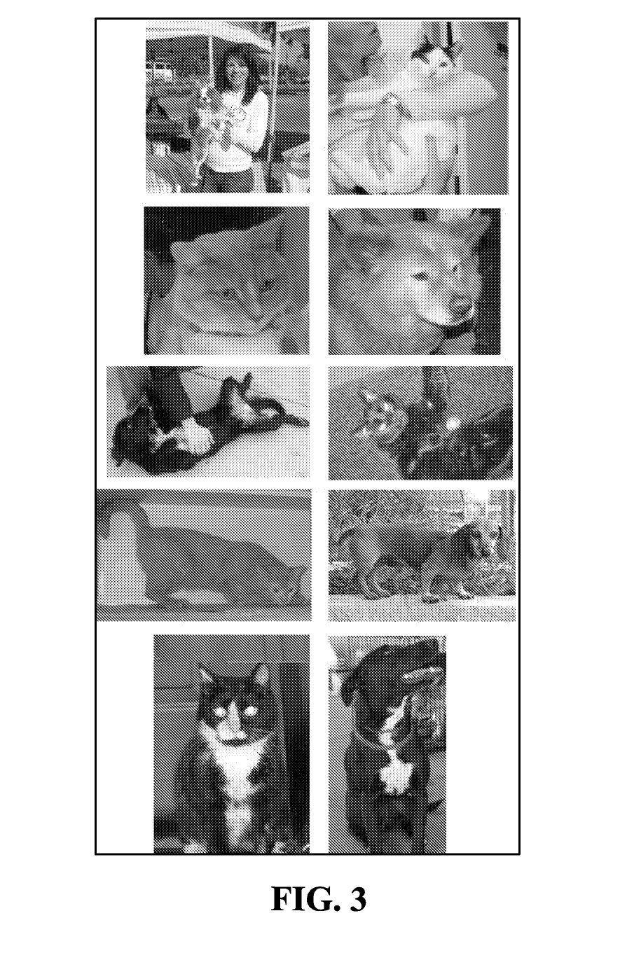

An example data store 104 that is private is owned by Petfinder®. Petfinder® is a web site devoted to finding homes for homeless animals. Petfinder® has a database of over 3 million cat and dog images, each of which is categorized with very high accuracy by human volunteers working in thousands of animal shelters throughout the United States and Canada. Petfinder's® database grows by nearly 10,000 images daily. Humans can readily distinguish a cat from a dog. However, computer algorithms have a much more difficult time distinguishing cats from dogs. Photos have a wide variety of backgrounds, angles, poses, lighting; factors that make accurate automatic classification difficult. FIG. 3 shows some example of side by side images of cats and dogs that demonstrate similarities that can cause problems for a machine vision system trying to tell the difference between a cat and a dog. As machine vision systems improve, their success rate at classifying these types of images will increase. This will require improvements such as the systems and methods disclosed in this invention for reducing the success rate of non-human users.

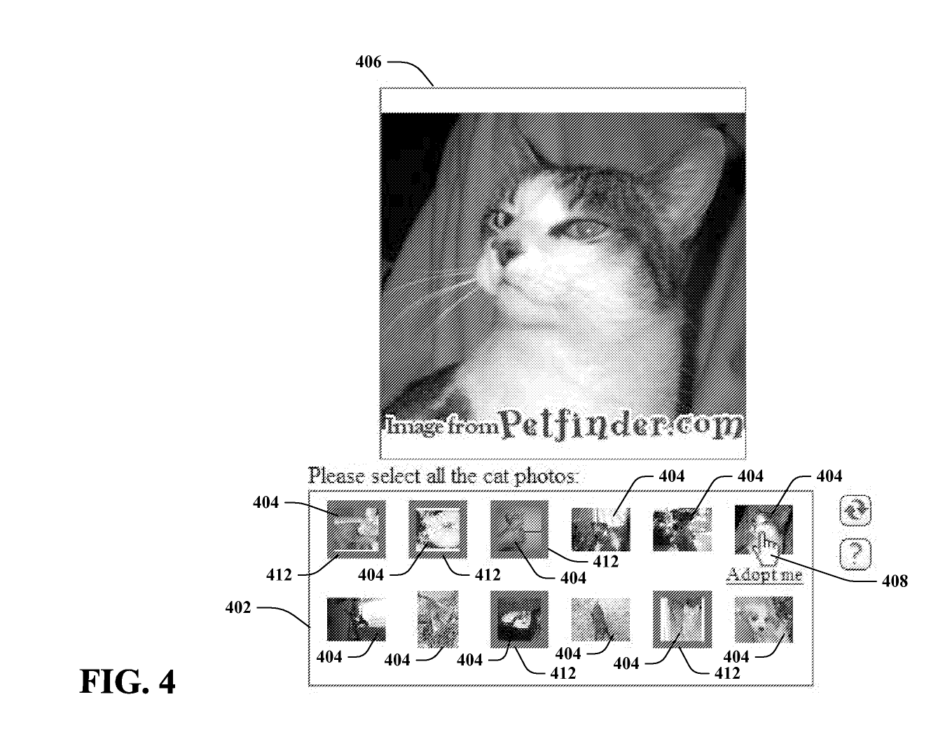

HIP component 102 is called by computer application 106 in order to verify that user 108 is a human. HIP component 102 can be local or remote from computer application 106. For example, HIP component 102 can be a web service that is employable by a plurality of remote web based computer applications 106, such as by calling an API. User 108 can be local or remote to computer application 106. User 108 interacts with computer application 106 in order to gain access to one or more feature of computer application 106. Computer application 106 can at anytime invoke HIP component 102 to determine if user 108 is a human. In the example of a free Internet e-mail service, user 108 may want to establish an e-mail account. Computer application 106 can invoke HIP component 102 before and/or after gathering account information from user 108. HIP component 102 will display a challenge to determine if user 108 is human. The challenge, for example, can consist of displaying one or more images from data store 104 that user 108 must classify. Each image can belong to one of a plurality of classes for which user 108 must classify the image. Any appropriate means to indicating the categorization of an image by user 108 can be employed, such as check boxes, highlighting, borders, fading, etc. For example as depicted in FIG. 4, the challenge can consist of twelve images from the Petfinder® database that user 108 must categorize each as cat or dog. When user 108 places cursor 408 over a pet image 404 in lower box 402, upper box 406 displays a larger image of pet image 404 that the cursor is hovering over. When user 108 selects a pet image 404 a border 412 is placed around the selected pet image 404 to indicate that user 108 has identified this image as a cat. In FIG. 4 for example, five pet images 404 have been selected as cats.

HIP component 102 employs one or more counting mechanisms, such as a token bucket algorithm, that are based upon one or more identifiers associates with user 108. The counting mechanism can be any appropriate means for tracking attempts at solving the challenge by user 108, such as a numerical counter or token bucket. The identifier can be any appropriate means for identifying user 108, such as an Internet Protocol (IP) address or user session. In a preferred embodiment a token bucket is associated with each IP address from which one or more users 108 attempts to solve the HIP challenge. In the preferred embodiment, a token bucket is also associated with a user session associated with user 108. Each user 108 has their own user session and each user session has its own token bucket. A user session can only be associated with a single IP address. A single IP address can have multiple user sessions. A HIP challenge for a single user 108 is associated with a single user session. Each IP-address token bucket is initialized with a predetermined value TB-Init, such as 100 tokens. Therefore, the IP address token bucket would have an initial value of TB-Init. If a user is attempting a challenge from an IP address for which there is already an IP address token bucket, then the IP address token bucket associated with user 108 IP address does not need to be initialized. If a user is attempting a challenge from an IP address for which there is not already an IP address token bucket, then the IP address token bucket associated with user 108 IP address is initialized TB-Init. When a user session is created for a user 108, the token bucket for the user session is initialized to the current value of the token bucket associated with the IP address associated with user 108. If a user is attempting a challenge from a user session for which there is already a user session token bucket, then the user session token bucket associated with user 108 does not need to be initialized. Also, when a user session is created for user 108 one or more tokens are subtracted from the IP address token bucket associated with the IP address associated with user 108. The token bucket for the user session is initialized to the current value of the IP address token bucket prior to subtracting the one or more tokens from the IP address token bucket. This prevents the user session token bucket from being initialized to zero when the IP address token bucket has a very low value. In an example of multiple users sharing a single IP address, such as from behind a corporate firewall, each user would have the same IP address. Anytime a user session is created for any of the users using the shared IP address, one or more tokens are subtracted from the IP address token bucket associated with the IP address. It should be noted that the number of tokens in any token bucket cannot drop below zero; that is, subtracting a token from a bucket is taken to mean that the new value is the maximum of the difference and zero. The number of tokens subtracted from or added to a bucket can be based upon the bucket type or activity type. For example, the user session bucket can subtract two buckets for each user session created, while the IP address token bucket can subtract 3 tokens for each incorrect response to a HIP challenge. This allows the different bucket types and different activity type to be weighted differently.

Each response submitted by user 108 to a HIP challenge results in one or more tokens being subtracted from each of the user session token bucket associated with user 108 and the IP address token bucket associated with user 108. Preferably, the tokens are subtracted from both buckets even if user 108 correctly responds to the challenge. Every time user 108 submits a correct response, a predetermined number TB-Refill of tokens are added to both the user session token bucket associated with user 108 and the IP address token bucket associated with user 108. The value of TB-Refill can be any appropriate number of tokens to be refilled into the bucket, such as based upon type of HIP, type of computer application 106, user 108, or level of desired security. For example, TB-Refill can be 5 in the example of TB-Init being 100. If a user 108 submits a HIP challenge response while their associated user session token bucket is empty, the user 108 response is determined to be incorrect, regardless of whether the response is actually correct or incorrect. A determination of actually being correct can be based upon user 108 getting all or a portion of the HIP challenge correct, which can be based for example upon type of HIP, type of computer application 106, user 108, or level of desired security. If a user 108 submits a HIP challenge response while their associated user session token bucket has at least one token, the user 108 response is determined to be correct or incorrect based upon whether the response is actually correct or incorrect. The IP address token bucket and user session token bucket associated are refilled when a correct response is submitted after determining that the user response will not be overridden by an empty value of the user session token bucket. The IP address token bucket can optionally be re-initialized to TB-Init tokens after a period of time. A predetermined value of TB-Max, such as for example 200, can also optionally be set for IP address token bucket to prevent human users who correctly solve the HIP challenge from adding a significant number of tokens in the IP address token bucket that an automated program can utilize to pass the HIP challenge.

An automated computer program trying to pass the HIP challenge a substantial number of times will quickly empty its IP address token bucket and user session token bucket, as its incorrect guesses will outnumber its correct guesses by more than a factor of TB-Refill. In this state where the user session token bucket is empty, the token bucket algorithm will force both automated computer programs and human users to correctly answer two challenges within TB-Refill attempts before they are determined to have a correct response. The effect of this process is that the token bucket algorithm will force both automated computer programs and human users to correctly solve challenges within TB-Refill attempts before they are determined to have a correct response.

The effect of the token bucket algorithm is to amplify the difference in skill between humans and non-human users. For example, if an automated computer program has a 1/4,096 chance of getting a single challenge correct, and TB-Refill is 5, the token bucket algorithm reduces the probability of getting a non-human user being judged as a human user to one per approximately 3.4 million attempts. If a human user, on the other hand, has a 99/100 chance of getting a single challenge correct, that user will only fail to solve two challenges within TB-Refill once in 10¹⁰ tries.

After user 108 has made their category selections for the images, user 108 submits the selections to HIP component 102, for example, by selecting a submit button on the display. HIP component 102 then determines if user 108 has correctly categorized the images and makes a determination as to whether user 108 is human or non-human based upon the token bucket algorithm described above. HIP component 102 can employ a token bucket algorithm (TBA) in making the determination, such that the user may be determined to be non-human even if the challenge is solved correctly, because the TBA has determined the count of failed attempts to be too high. The determination can be a binary determination or a percentage indication of the likelihood that the user is a human. For example, a percentage determination can be based upon a statistical difficulty associated with an image that is based upon counts of users determined to be human that incorrectly categorized the image or can be based upon partial credit given by a partial credit algorithm. Co-pending U.S. Pat. No. ______ by the same inventors of this application titled “IMPROVING HUMAN PERFORMANCE IN HUMAN INTERACTIVE PROOFS USING PARTIAL CREDIT”, included herein by reference, discloses various techniques for applying partial credit to responses to HIP challenges.

HIP component 102 notifies computer application 106 of the determination. Computer application 106 can then employ the determination in assessing whether access should be provided to user 108. For example, if the determination is that user 108 is human then access to features of computer application can be granted to user 108. If the determination is that user 108 is non-human access can be denied by computer application 106. If the determination is in the form of percentage likelihood that user 108 is human, computer application 106 can employs the percentage with an algorithm based on the level of security desired to grant or restrict access. For example, if computer application is willing to trade-off a little security in order to let more potentially real humans gain access, then the algorithm may grant access as long as the percentage is above a predetermined threshold.

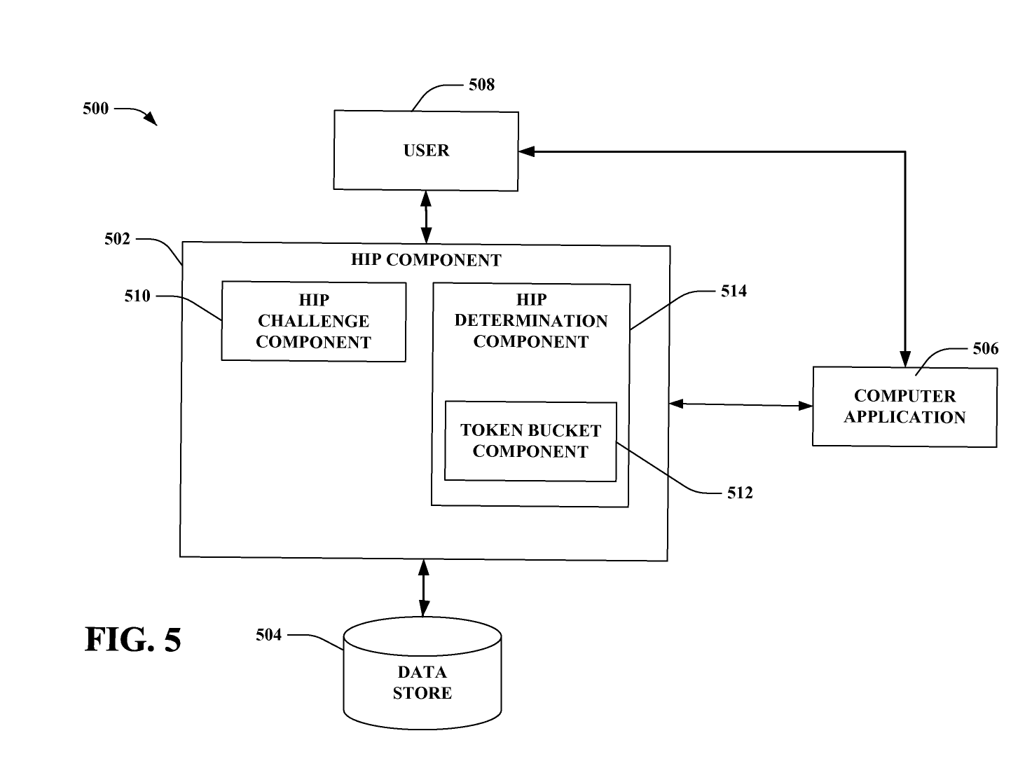

Referring to FIG. 5, there is illustrated a general block diagram HIP system 500 employing a counting mechanism to distinguish between human and non-human users. System 500 includes a Human Interactive Proof (HIP) component 502 that distinguishes between a human and a non-human. HIP component 502 presents one or more challenges, such as class I or II CAPTCHAs™, to user 508 to determine if user 508 is a human or a non-human user. The challenges can include, for example, presenting one or more images to user 508 from data store 504 that user 508 must correctly categorize before being allowed to partially or fully employ computer application 506. Data store 504 can contain a large number of images that have been substantially accurately manually categorized by one or more humans.

HIP component 502 is called by computer application 506 in order to verify that user 508 is a human. HIP component 502 can be local or remote from computer application 506. User 508 interacts with computer application 506 in order to gain access to one or more feature of computer application 506. Computer application 506 can at anytime invoke HIP component 502 to determine if user 508 is a human. HIP challenge component 510 will present a challenge to user 508 determine if user 508 is human.

After user 508 has made their category selections for the images, user 508 submits the selections to HIP component 502, for example, by selecting a submit button on the display. HIP determination component 514 then determines which portions of user 508 response to the challenge are correct and incorrect. HIP determination component 514 can employ token bucket component 512 in making a determination if user 508 response is correct. Token bucket component 512 can employ a token bucket algorithm to determine if the response submitted by user 508 will be determined to be correct based upon the actual correctness of the response or will be overridden as incorrect based upon a token count. The token bucket algorithm can employ IP address token buckets and user session token buckets. HIP determination component 514 notifies computer application 506 of the determination. The determination can be a binary determination or a percentage indication of the likelihood that the user is a human. For example, a percentage determination can be based upon a statistical difficulty assigned to an image by HIP statistics component 512 that is based upon counts of users determined to be human that incorrectly categorized the image. Computer application 506 can then employ the determination in assessing whether access should be provided to user 508.

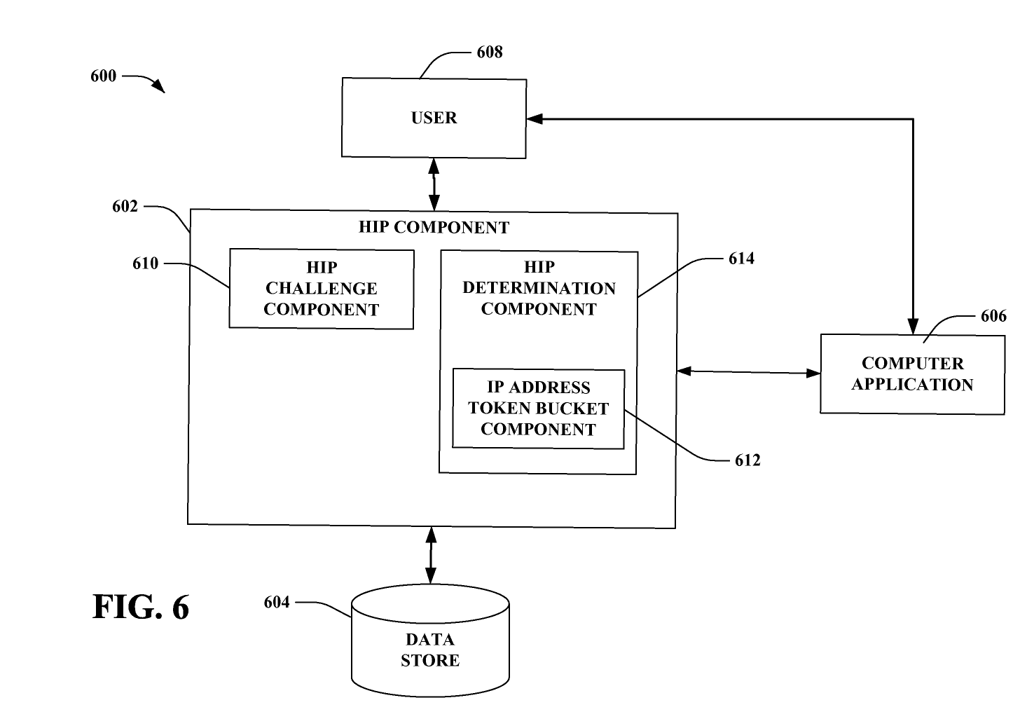

Referring to FIG. 6, there is illustrated a general block diagram HIP system 600 employing an IP address based counting mechanism to distinguish between human and non-human users. System 600 includes a Human Interactive Proof (HIP) component 602 that distinguishes between a human and a non-human. HIP component 602 presents one or more challenges, such as class I or II CAPTCHAs™, to user 608 to determine if user 608 is a human or a non-human user. The challenges can include, for example, presenting one or more images to user 608 from data store 604 that user 608 must correctly categorize before being allowed to partially or fully employ computer application 606. Data store 604 can contain a large number of images that have been substantially accurately manually categorized by one or more humans.

HIP component 602 is called by computer application 606 in order to verify that user 608 is a human. HIP component 602 can be local or remote from computer application 606. User 608 interacts with computer application 606 in order to gain access to one or more feature of computer application 606. Computer application 606 can at anytime invoke HIP component 602 to determine if user 608 is a human. HIP challenge component 610 will present a challenge to user 608 determine if user 608 is human.

After user 608 has made their category selections for the images, user 608 submits the selections to HIP component 602, for example, by selecting a submit button on the display. HIP determination component 614 then determines which portions of user 608 response to the challenge are correct and incorrect. HIP determination component 614 can employ token bucket component 612 in making a determination if user 608 response is correct. Token bucket component 612 can employ a token bucket algorithm to determine if the response submitted by user 608 will be determined to be correct based upon the actual correctness of the response or will be overridden as incorrect based upon a token count. The token bucket algorithm can employ IP address token buckets. In an embodiment a token bucket is associated with each IP address from which one or more users 608 attempts to solve the HIP challenge. Each IP-address token bucket is initialized with a predetermined value TB-Init, such as 100 tokens. Therefore, the IP address token bucket would have an initial value of TB-Init. If a user is attempting a challenge from an IP address for which there is already an IP address token bucket, then the IP address token bucket associated with user 608 IP address does not need to be initialized. If a user is attempting a challenge from an IP address for which there is not already an IP address token bucket, then the IP address token bucket associated with user 608 IP address is initialized TB-Init. It should be noted that the number of tokens in any token bucket cannot drop below zero; that is, subtracting a token from a bucket is taken to mean that the new value is the maximum of the difference and zero.

Each response submitted by user 608 to a HIP challenge results in one or more tokens being subtracted from the IP address token bucket associated with user 608. Preferably, the tokens are subtracted from the buckets even if user 608 correctly responds to the challenge. Every time user 608 submits a correct response, a predetermined number TB-Refill of tokens are added to the IP address token bucket associated with user 608. The value of TB-Refill can be any appropriate number of tokens to be refilled into the bucket, such as based upon type of HIP, type of computer application 606, user 108, or level of desired security. For example, TB-Refill can be 5 in the example of TB-Init being 100. If a user 608 submits a HIP challenge response while their associated IP address session token bucket is empty, the user 608 response is determined to be incorrect, regardless of whether the response is actually correct or incorrect. If a user 608 submits a HIP challenge response while their associated IP address session token bucket has at least one token, the user 608 response is determined to be correct or incorrect based upon whether the response is actually correct or incorrect. The IP address token bucket is refilled when a correct response is submitted after determining if the user response will be overridden by the value of the IP address token bucket. The IP address token bucket can optionally be re-initialized to TB-Init tokens after a period of time, such as for example, hourly, daily, or weekly. A predetermined value of TB-Max, such as for example 200, can also optionally be set for IP address token bucket to prevent human users who correctly solve the HIP challenge from adding a significant number of tokens in the IP address token bucket that an automated program can utilize to pass the HIP challenge.

HIP determination component 614 notifies computer application 606 of the determination. The determination can be a binary determination or a percentage indication of the likelihood that the user is a human. For example, a percentage determination can be based upon a statistical difficulty assigned to an image by HIP statistics component 612 that is based upon counts of users determined to be human that incorrectly categorized the image. Computer application 606 can then employ the determination in assessing whether access should be provided to user 608.

In view of the exemplary systems shown and described supra, methodologies that may be implemented in accordance with the disclosed subject matter will be better appreciated with reference to the flow charts described below. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

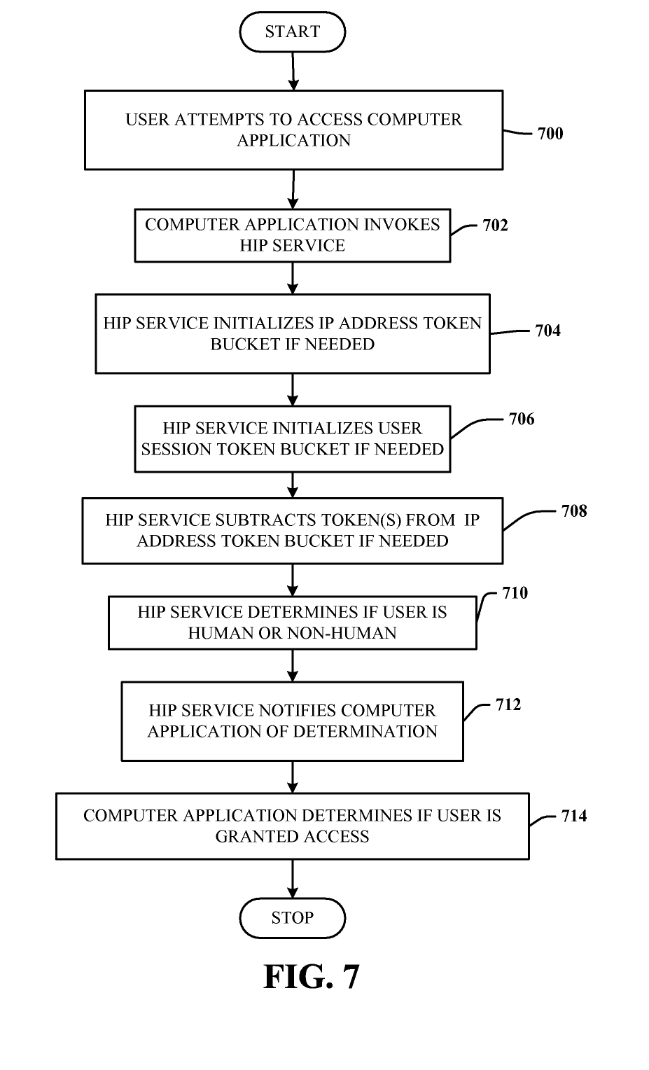

Referring now to FIG. 7 there is illustrated a flow chart of one methodology for a computer application to employ a HIP service that utilizes token buckets to distinguish between a human and non-human user taking a HIP challenge. At 700 a user attempts to access a computer application. At 702 the computer application invokes a HIP service. At 704, the HIP service initializes an IP address token bucket associated with the user's IP address if needed. If a previous attempt has been made to solve a HIP challenge from the user's IP address, the IP address token bucket associated with the user's IP address will already have been initialized. At 706, the HIP service initializes, if needed, a user session token bucket associated with the user to the current value of the IP address token bucket associated with the user. If a previous attempt has been made to solve a HIP challenge from the user session associated with the user, the user session token bucket associated with the user will already have been initialized. At 708, the HIP service subtracts one or more tokens from the IP address token bucket associated with the user if needed. The tokens are only subtracted from the IP address bucket for a new user session. If a previous attempt has been made to solve a HIP challenge from the user session associated with the user, no tokens are subtracted from the IP address token bucket associated with the user. At 710, the HIP service determines if the user is a human or non-human. At 712, the HIP service notifies the computer application of the determination. At 714, the computer application employs the determination from the HIP service to decide if the user will be granted access to features of the computer application.

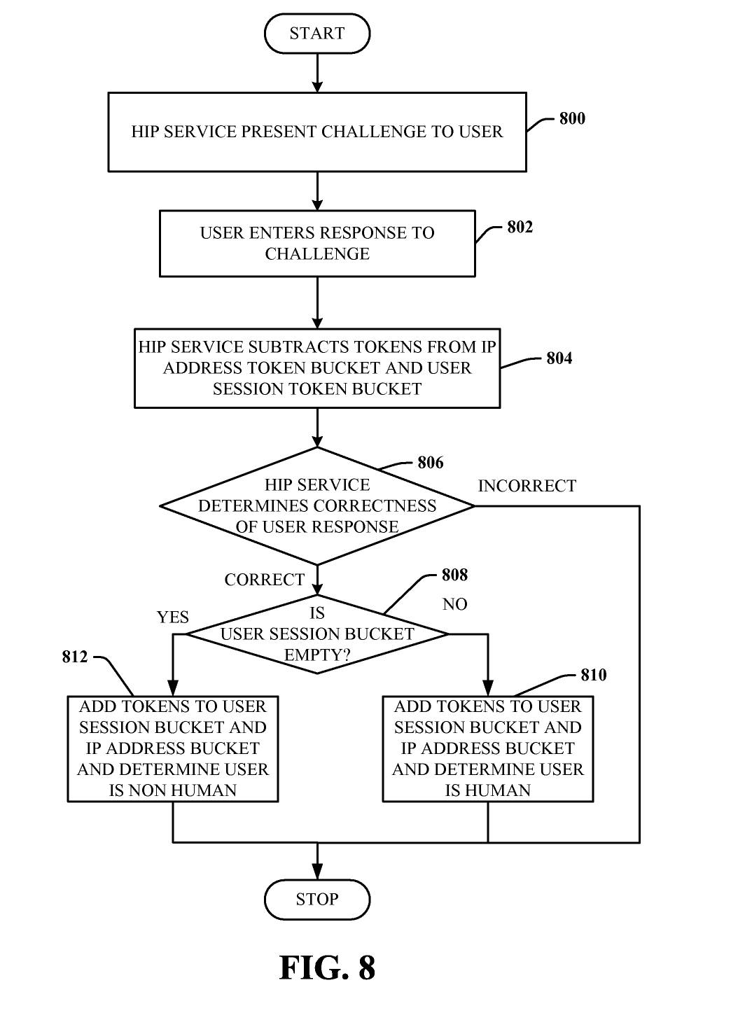

Referring to FIG. 8 there is illustrated a flow chart of one methodology for a HIP service, for example from 710 of FIG. 7, to employ token buckets to distinguish between a human and non-human user taking the HIP challenge. At 800 HIP service presents a HIP challenge to a user. At 802, the user enters their response to the HIP challenge to the HIP service. At 804, the HIP service subtracts one or more tokens from IP address token bucket associated with IP address associated with the user and subtracts one or more tokens from user session token bucket associated with user session associated with the user. At 806, the HIP service makes a determination as to the correctness of the user's response and proceeds to 806. If the HIP service determines response to be correct, method proceeds to 808. If the HIP service determines user response to be incorrect, determine user is non human. At 806, if user session token bucket is empty, proceed to 812. If user session token bucket is not empty proceed to 810. At 810, add predetermined number of refill tokens to IP address token bucket associated with the user and add predetermined number of refill tokens to user session token bucket associated with the user, and determine user is human. At 812, add predetermined number of refill tokens to IP address token bucket associated with the user and add predetermined number of refill tokens to user session token bucket associated with the user, and determine user is non human.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

The benefit of object technology arises out of three basic principles: encapsulation, polymorphism and inheritance. Objects hide or encapsulate the internal structure of their data and the algorithms by which their functions work. Instead of exposing these implementation details, objects present interfaces that represent their abstractions cleanly with no extraneous information. Polymorphism takes encapsulation one-step further—the idea being many shapes, one interface. A software component can make a request of another component without knowing exactly what that component is. The component that receives the request interprets it and figures out according to its variables and data how to execute the request. The third principle is inheritance, which allows developers to reuse pre-existing design and code. This capability allows developers to avoid creating software from scratch. Rather, through inheritance, developers derive subclasses that inherit behaviors that the developer then customizes to meet particular needs.

In particular, an object includes, and is characterized by, a set of data (e.g., attributes) and a set of operations (e.g., methods), that can operate on the data. Generally, an object's data is ideally changed only through the operation of the object's methods. Methods in an object are invoked by passing a message to the object (e.g., message passing). The message specifies a method name and an argument list. When the object receives the message, code associated with the named method is executed with the formal parameters of the method bound to the corresponding values in the argument list. Methods and message passing in OOP are analogous to procedures and procedure calls in procedure-oriented software environments.

However, while procedures operate to modify and return passed parameters, methods operate to modify the internal state of the associated objects (by modifying the data contained therein). The combination of data and methods in objects is called encapsulation. Encapsulation provides for the state of an object to only be changed by well-defined methods associated with the object. When the behavior of an object is confined to such well-defined locations and interfaces, changes (e.g., code modifications) in the object will have minimal impact on the other objects and elements in the system.

Each object is an instance of some class. A class includes a set of data attributes plus a set of allowable operations (e.g., methods) on the data attributes. As mentioned above, OOP supports inheritance—a class (called a subclass) may be derived from another class (called a base class, parent class, etc.), where the subclass inherits the data attributes and methods of the base class. The subclass may specialize the base class by adding code which overrides the data and/or methods of the base class, or which adds new data attributes and methods. Thus, inheritance represents a mechanism by which abstractions are made increasingly concrete as subclasses are created for greater levels of specialization.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

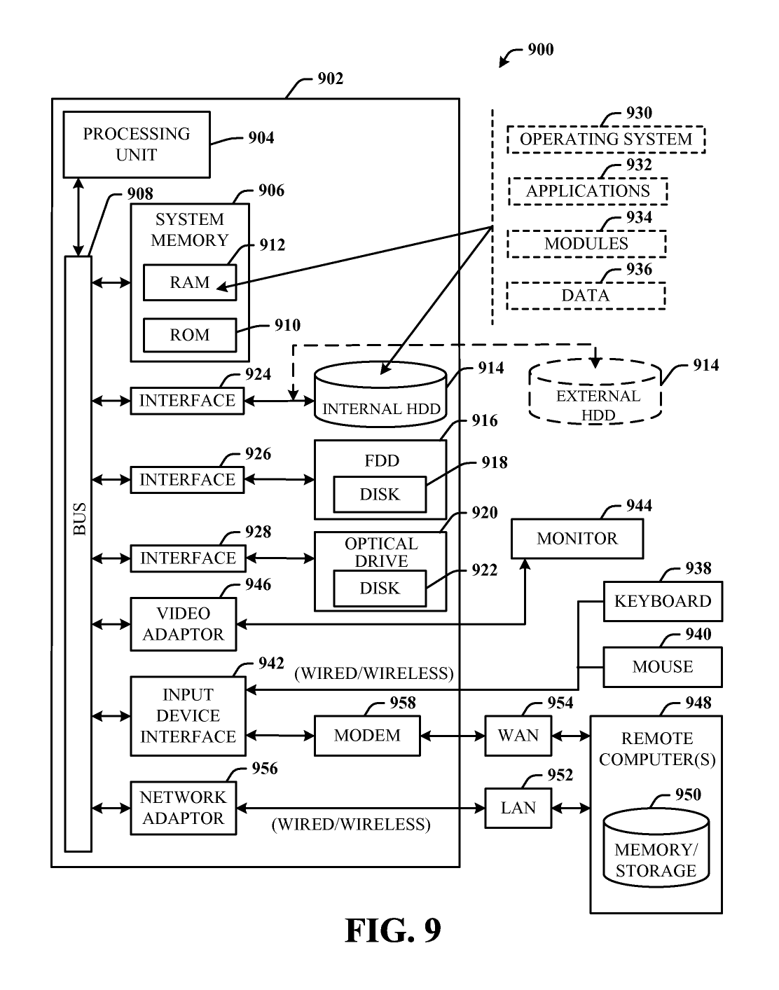

Referring now to FIG. 9, there is illustrated a block diagram of a computer operable to execute the disclosed system. In order to provide additional context for various aspects thereof, FIG. 9 and the following discussion are intended to provide a brief, general description of a suitable computing environment 900 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the claimed subject matter.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that the claimed subject matter can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11 g applies to wireless LANs and provides 20+Mbps in the 2.4 GHz band. Products can contain more than one band (e.g., dual band), so the networks can provide real-world performance similar to the basic 10 BaseT wired Ethernet networks used in many offices.

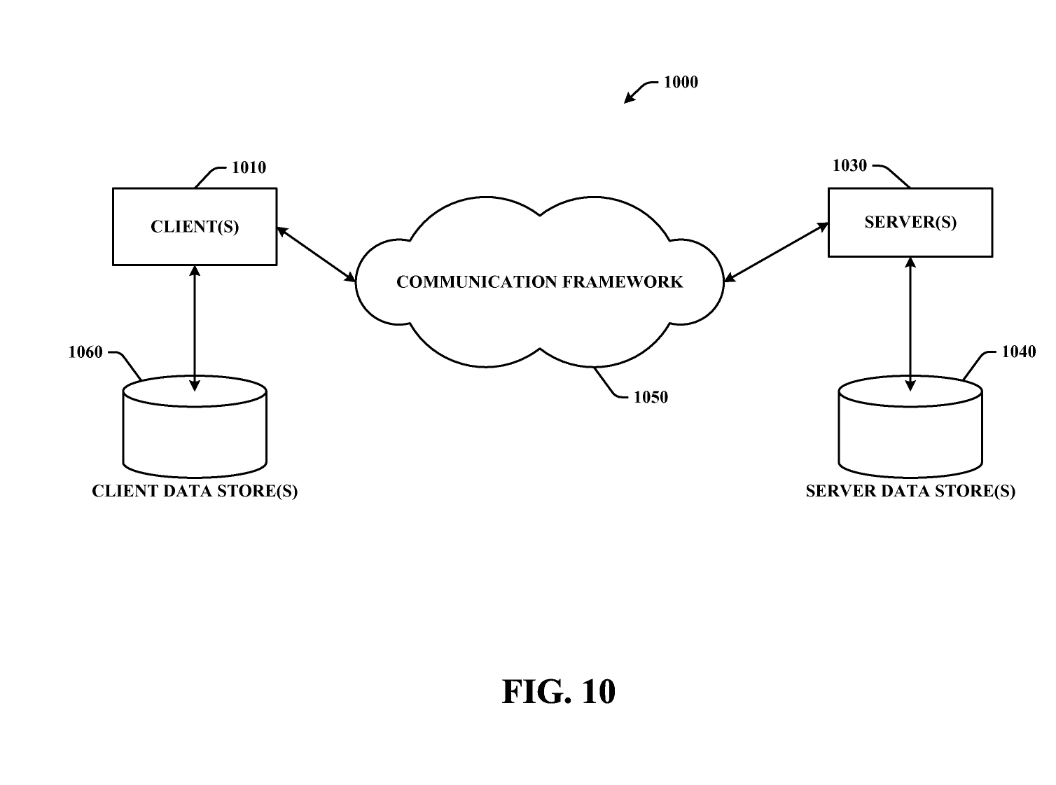

Referring now to FIG. 10, there is illustrated a schematic block diagram of an exemplary computing environment 1000 for processing the inference-based query completion architecture in accordance with another aspect. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for distinguishing between a human and non-human user, comprising:
a human interactive proof (HIP) challenge component that displays a HIP challenge to a user,
HIP determination component that determines if the user is a human or non-human based upon a response to the challenge provided by the user, wherein the HIP determination component employs at least one token bucket associated with the user in making the determination.

2. The system of claim 1, wherein the token bucket is associated with an IP address from which the user is attempting to solve the challenge and the IP address token bucket is initialized to a predetermined initial value.

3. The system of claim 2, wherein a user session token bucket is associated with a user session from which the user is attempting to solve the challenge and the user session token bucket is initialized to a current value of the IP address token bucket.

4. The system of claim 3, wherein the HIP determination component subtracts at least one token from the IP address token bucket upon creation of a user session.

5. The system of claim 4, wherein the HIP determination component subtracts at least one token from the IP address token bucket and subtracts one token from the user session token bucket upon the user submitting a response to the challenge.

6. The system of claim 5, wherein the HIP determination component determines the user is non human if the token bucket is empty.

7. The system of claim 5, wherein the HIP determination component determines that the user is non human or human based upon the response submitted by the user if the token bucket is not empty.

8. The system of claim 7, wherein the HIP determination component refills the IP address token bucket and user session token bucket by a predetermined refill value if the user response is correct.

9. The system of claim 1, wherein the HIP determination component initializes the token bucket to a predetermined initial value.

10. The system of claim 9, wherein the HIP determination component subtracts at least one token from the token bucket upon the user submitting a response to the challenge.

11. The system of claim 10, wherein the HIP determination component determines the user is non human if the token bucket is empty.

12. The system of claim 10, wherein the HIP determination component determines that the user is non human or human based upon the response submitted by the user if the token bucket is not empty.

13. The system of claim 12, wherein the HIP determination component refills the token bucket by a predetermined refill value if the user response is correct.

14. A method for distinguishing between a human and non-human user, comprising:
displaying a HIP challenge to a user; and
determining if the user is a human or non-human based upon a response to the challenge provided by the user, wherein at least one token bucket associated with the user is employed in making the determination.

15. The method of claim 14, further comprising:
associating an IP address token bucket to the user that is associated with an IP address from which the user is attempting to solve the challenge;
initializing the IP address token bucket to a predetermined initial value;
associating a user session token bucket to the user that is associated with a user session from which the user is attempting to solve the challenge; and
initializing the user session token bucket to a current value of the IP address token bucket.

16. The method of claim 15, subtracting at least one token from the IP address token bucket upon creation of a user session.

17. The method of claim 16, subtracting at least one token from the IP address token bucket and subtracting one token from the user session token bucket upon the user submitting a response to the challenge.

18. The method of claim 17, further comprising:
determining that the user is non human if the token bucket is empty; and
determining that the user non human or human based upon the response submitted by the user if the token bucket is not empty.

19. The method of claim 18, refilling the IP address token bucket and user session token bucket by a predetermined refill value if the user response is correct.

20. A system for distinguishing between a human and non-human user, comprising:
means for displaying a HIP challenge to a user; and
means for determining if the user is a human or non-human based upon a response to the challenge provided by the user, wherein at least one token bucket associated with the user is employed in making the determination.
